(19) United States
(12) Patent Application Publication
(10) Pub. No.: US 2017/0305392 A1
(43) Pub. Date: Oct. 26, 2017

(54) FLUID LEVEL SENSOR-ATTACHED MOTOR PUMP FOR WASHER FLUID

(71) Applicant: Kyu Han LEE, Seongnam-si, Gyeonggi-do (KR)

(72) Inventor: Kyu Han LEE, Seongnam-si, Gyeonggi-do (KR)

(21) Appl. No.: 15/520,223

(22) PCT Filed: Feb. 10, 2015
(86) PCT No.: PCT/KR2015/001303

§ 371 Date: Apr. 19, 2017

(30) Foreign Application Priority Data
Nov. 5, 2014 (KR) 10-2014-0152652

(51) Int. Cl. B60S 1/50; F04D 15/02; B60S 1/08

(52) U.S. Cl. CPC B60S 1/50; B60S 1/0862; F04D 15/0209

(57) ABSTRACT

The present invention relates to a fluid level sensor-attached motor pump for a washer fluid, in which a fluid level sensor for detecting the remaining amount of a washer fluid stored in a washer fluid reservoir and outputting a detection signal is integrally mounted to a motor pump for a washer fluid so that an operator can check the remaining amount of the washer fluid through a dashboard of a vehicle and thus can replenish an insufficient washer fluid, in which the fluid level sensor is integrally mounted to the motor pump for a washer fluid to solve a problem in that the motor pump and the fluid level sensor are separately wiring-connected to the washer fluid reservoir to thereby deteriorate workability of wiring so that workability of wiring can be increased and the wiring can be simplified to reduce a defective proportion, in which the motor pump for a washer fluid and the fluid level sensor are integrally manufactured so that the manufacturing cost can be reduced, and in which the fluid level sensor for detecting the remaining amount of a washer fluid and outputting a detection signal is manufactured by selecting any one of a combination of a magnet and a Hall sensor, a combination of a magnet and a reed switch, and a combination of a Hall sensor and a buoyancy device mounted with a magnet so that the improvement in performance can be achieved through the use of a magnetic Hall sensor having reliability.

### TECHNICAL FIELD

The present invention relates to a fluid level sensor-attached motor pump for a washer fluid, in which a fluid level sensor for detecting the remaining amount of a washer fluid stored in a washer fluid reservoir and outputting a detection signal is integrally mounted to a motor pump for a washer fluid so that an operator can check the remaining amount of the washer fluid through a dashboard of a vehicle and thus can replenish an insufficient washer fluid, in which the fluid level sensor is integrally mounted to the motor pump for a washer fluid to solve a problem in that the motor pump and the fluid level sensor are separately wiring-connected to the washer fluid reservoir to thereby deteriorate workability of wiring so that workability of wiring can be increased and the wiring can be simplified to reduce a defective proportion, in which the motor pump for a washer fluid and the fluid level sensor are integrally manufactured so that the manufacturing cost can be reduced, and in which the fluid level sensor for detecting the remaining amount of a washer fluid and outputting a detection signal is manufactured by selecting any one of a combination of a magnet and a Hall sensor, a combination of a magnet and a reed switch, and a combination of a Hall sensor and a buoyancy device mounted with a magnet so that the improvement in performance can be achieved through the use of a magnetic Hall sensor having reliability.

### BACKGROUND ART

In general, various devices are intensively installed at a driver's seat of a vehicle to control respective parts of the vehicle. In particular, a steering wheel is installed to allow the driver to perform a steering operation, and a dashboard is installed which has intensively mounted thereon a speedometer, a temperature gauge, a fuel gauge and the like.

A multifunctional switch is installed at a side of the steering wheel so as to operate a wiper mounted on a windshield, spray a windshield wiper fluid (or a washer fluid), and adjust the speed of the windshield wiper. Thus, the multifunctional switch is manipulated by the driver to operate a wiper motor to cause the windshield wiper to wipe the windshield.

In addition, a wiper driver of a vehicle is an apparatus that drives the windshield wiper to remove dust, snow or rain on the outer surface of the windshield to allow the driver to secure his or her front field of view during the traveling of the vehicle. A function of supplying a washer fluid to this apparatus is performed by a motor pump.

However, conventionally, there is a problem in that a motor pump and a fluid level sensor are separately wiring-connected to a washer fluid reservoir, thus resulting in a deterioration of workability of wiring and an increase in the manufacturing cost. Moreover, the fluid level sensor is directly fixed to the washer fluid reservoir, which contributes to an increase in a defective proportion.

Besides, Korean Patent Laid-Open Publication No. 1997-0040206 (laid open on Jul. 24, 1997) discloses a cold and hot water system for a windshield wiper. However, such a cold and hot water system entails a problem in that in the case where frost, dust or snow is accumulated on the outer surface of a vehicle windshield in the winter season, a user suffers from an inconvenience of having to remove frost, dust or snow on the windshield personally when the washer fluid is insufficient.

Therefore, there is an urgent need for the development of a fluid level sensor-attached motor pump for a washer fluid, in which a fluid level sensor for detecting the remaining amount of a washer fluid stored in a washer fluid reservoir and outputting a detection signal is integrally mounted to a motor pump for a washer fluid so that an operator can check the remaining amount of the washer fluid through a dashboard of a vehicle and thus can replenish an insufficient washer fluid, in which the fluid level sensor is integrally mounted to the motor pump for a washer fluid to solve a problem in that the motor pump and the fluid level sensor are separately wiring-connected to the washer fluid reservoir to thereby deteriorate workability of wiring so that workability of wiring can be increased and the wiring can be simplified to reduce a defective proportion, and in which the fluid level sensor for detecting the remaining amount of a washer fluid and outputting a detection signal is manufactured by selecting any one of a combination of a magnet and a Hall sensor, a combination of a magnet and a reed switch, and a combination of a Hall sensor and a buoyancy device mounted with a magnet so that the improvement in performance can be achieved through the use of a magnetic Hall sensor having reliability.

### DISCLOSURE OF INVENTION

### Technical Problem

Accordingly, the present invention has been made in order to solve the above-described problems occurring in the prior art, and it is an object of the present invention to provide a fluid level sensor-attached motor pump for a washer fluid, in which a fluid level sensor for detecting the remaining amount of a washer fluid stored in a washer fluid reservoir and outputting a detection signal is integrally mounted to a motor pump for a washer fluid so that an operator can check the remaining amount of the washer fluid through a dashboard of a vehicle and thus can replenish an insufficient washer fluid.

Another object of the present invention is to provide a fluid level sensor-attached motor pump for a washer fluid, in which the fluid level sensor is integrally mounted to the motor pump for a washer fluid to solve a problem in that the motor pump and the fluid level sensor are separately wiring-connected to the washer fluid reservoir to thereby deteriorate workability of wiring so that workability of wiring can be increased and the wiring can be simplified to reduce a defective proportion.

Still another object of the present invention is to provide a fluid level sensor-attached motor pump for a washer fluid, in which the motor pump for a washer fluid and the fluid level sensor are integrally manufactured so that the manufacturing cost can be reduced.

Yet another object of the present invention is to provide a fluid level sensor-attached motor pump for a washer fluid, in which the fluid level sensor for detecting the remaining amount of a washer fluid and outputting a detection signal is manufactured by selecting any one of a combination of a magnet and a Hall sensor, a combination of a magnet and a reed switch, and a combination of a Hall sensor and a buoyancy device mounted with a magnet so that the improvement in performance can be achieved through the use of a magnetic Hall sensor having reliability.

### Technical Solution

To achieve the above objects, in accordance with a preferred embodiment of the present invention, there is provided a fluid level sensor-attached motor pump for a washer fluid, including: a casing configured to protect the constituent components of the motor pump; a power supply connector configured to supply electric power to the motor pump; a motor assembly configured to receive the electric power from the power supply connector so as to be driven to allow a washer fluid stored in a washer fluid reservoir to be sucked into the casing or discharged from the casing; a fan rotated by the drive of the motor assembly; and a fluid level sensor inserted into a tube formed at a lower end portion of a pumping casing in which the fan is mounted, the tube having formed therein a suction port through which the washer fluid is sucked into the casing, or a tube formed at an outer circumferential side of the pumping casing and having formed therein a discharge port through which the washer fluid is discharged from the casing, the fluid level sensor being configured to detect the remaining amount of the washer fluid in the washer fluid reservoir using either a combination of a magnet and a Hall sensor or a combination of the magnet and a reed switch and output a detection signal.

In the present invention, the casing may include: a power supply connector casing configured to surround the power supply connector; a motor cover coupled at an upper end portion thereof to a lower end portion of the power supply connector casing and coupled at a lower end portion thereof to an upper end portion of the pumping casing, the motor cover being configured to protect the motor assembly 20; and the pumping casing configured to surround the fan and formed with the suction port and the discharge port for the washer fluid.

In the present invention, the fluid level sensor-attached motor pump 100 may further include a rubber packing interposed between the motor assembly and the fan and between the Hall sensor and the magnet, or between the motor assembly and the fan and around the tube formed at the lower end portion of the pumping casing so as to maintain airtightness.

In the present invention, a step may be formed on the tube having formed therein the suction port through which the washer fluid is sucked into the pumping casing so as to prevent escape of a lower end portion of a buoyant magnet that is fit around the tube.

To achieve the above objects, in accordance with another preferred embodiment of the present invention, there is also provided a fluid level sensor-attached motor pump for a washer fluid, including: a power supply connector casing coupled to an upper end portion of a pumping casing and configured to surround a power supply connector; a power supply connector configured to supply electric power to the motor pump; a motor assembly configured to receive the electric power from the power supply connector so as to be driven to allow a washer fluid stored in a washer fluid reservoir to be sucked into the pumping casing or discharged from the pumping casing through a discharge port; a fan rotated by the drive of the motor assembly; and a fluid level sensor inserted into a tube formed at a lower outer circumferential side of the pumping casing in which the motor assembly and the fan are mounted, the tube having formed therein a suction port through which the washer fluid is sucked into the pumping casing, the fluid level sensor being configured to detect the remaining amount of the washer fluid in the washer fluid reservoir using a combination of a Hall sensor and a buoyancy device connected to a magnet by means of a hinge and output a detection signal.

In the present invention, the Hall sensor may be implemented as a magnetic sensor whose electrical resistance varies under a magnetic field and which uses a semiconductor Hall element of InSb, InAs or GaAs.

### Advantageous Effects

As described above, the fluid level sensor-attached motor pump for a washer fluid according to the present invention has the following effects.

First, the present invention allows a fluid level sensor for detecting the remaining amount of a washer fluid stored in a washer fluid reservoir and outputting a detection signal to be integrally mounted to a motor pump for a washer fluid so that an operator can check the remaining amount of the washer fluid through a dashboard of a vehicle and thus can replenish an insufficient washer fluid.

Second, the present invention allows the fluid level sensor to be integrally mounted to the motor pump for a washer fluid to solve a problem in that the motor pump and the fluid level sensor are separately wiring-connected to the washer fluid reservoir to thereby deteriorate workability of wiring so that workability of wiring can be increased and the wiring can be simplified to reduce a defective proportion.

Third, the present invention allows the motor pump for a washer fluid and the fluid level sensor to be integrally manufactured so that the manufacturing cost can be reduced.

Fourth, the present invention allows the fluid level sensor for detecting the remaining amount of a washer fluid and outputting a detection signal to be manufactured by selecting any one of a combination of a magnet and a Hall sensor, a combination of a magnet and a reed switch, and a combination of a Hall sensor and a buoyancy device mounted with a magnet so that the improvement in performance can be achieved through the use of a magnetic Hall sensor having reliability.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an assembled perspective view showing a fluid level sensor-attached motor pump for a washer fluid mounted to a washer fluid reservoir, in which the fluid level sensor is mounted to a tube formed at an outer circumferential side of a pumping casing according to an embodiment of the present invention;

FIG. 2 shows a non-operating state (a) and an operating state (b) of a washer fluid warning lamp in a fluid level sensor-attached motor pump for a washer fluid mounted to a washer fluid reservoir, in which the fluid level sensor is mounted to a tube formed at the outer circumferential side of a pumping casing according to an embodiment of the present invention;

FIG. 3 is an exploded perspective view showing a fluid level sensor-attached motor pump for a washer fluid according to an embodiment of the present invention;

FIG. 4 is an assembled perspective view showing a fluid level sensor-attached motor pump for a washer fluid mounted to a washer fluid reservoir, in which the fluid level sensor is mounted to a tube formed at a lower end portion of a pumping casing according to another embodiment of the present invention;

FIG. 5 shows a non-operating state (a) and an operating state (b) of a washer fluid warning lamp in a fluid level sensor-attached motor pump for a washer fluid mounted to a washer fluid reservoir, in which the fluid level sensor is mounted to a tube formed at the lower end portion of a pumping casing according to another embodiment of the present invention;

FIG. 6 is an exploded perspective view showing a fluid level sensor-attached motor pump for a washer fluid according to another embodiment of the present invention;

FIG. 7 is an assembled perspective view showing a fluid level sensor-attached motor pump for a washer fluid mounted to a washer fluid reservoir, in which the fluid level sensor is mounted to a branched tube of a pumping casing into which a washer fluid is sucked according to still another embodiment of the present invention;

FIG. 8 shows a non-operating state (a) and an operating state (b) of a washer fluid warning lamp in a fluid level sensor-attached motor pump for a washer fluid mounted to a washer fluid reservoir, in which the fluid level sensor is mounted to the branched tube of a pumping casing into which a washer fluid is sucked according to still another embodiment of the present invention; and

FIG. 9 is an exploded perspective view showing a fluid level sensor-attached motor pump for a washer fluid according to still another embodiment of the present invention.

### BEST MODE FOR CARRYING OUT THE INVENTION

Reference will be now made in detail to embodiments of the present invention with reference to the attached drawings. In the following description, the detailed description on known function and constructions unnecessarily obscuring the subject matter of the present invention will be avoided hereinafter. Also, the terms used herein are defined in consideration of the function of the present invention, which may vary according to an intention of a user or an operator or according to custom. Thus, the definition of such terms should be made based on the contents throughout the specification disclosing a fluid level sensor-attached motor pump for a washer fluid according to the present invention.

Hereinafter, a fluid level sensor-attached motor pump for a washer fluid according to preferred embodiments of the present invention will be described in detail with reference to the accompanying drawings.

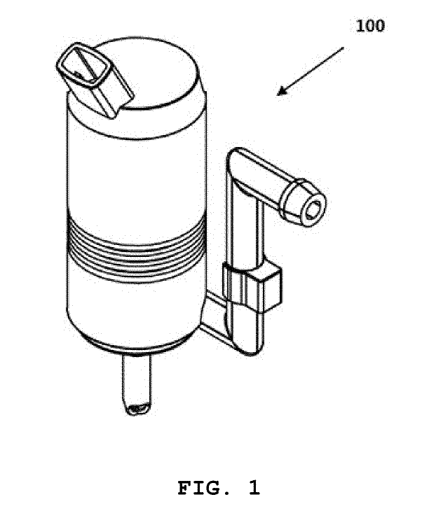

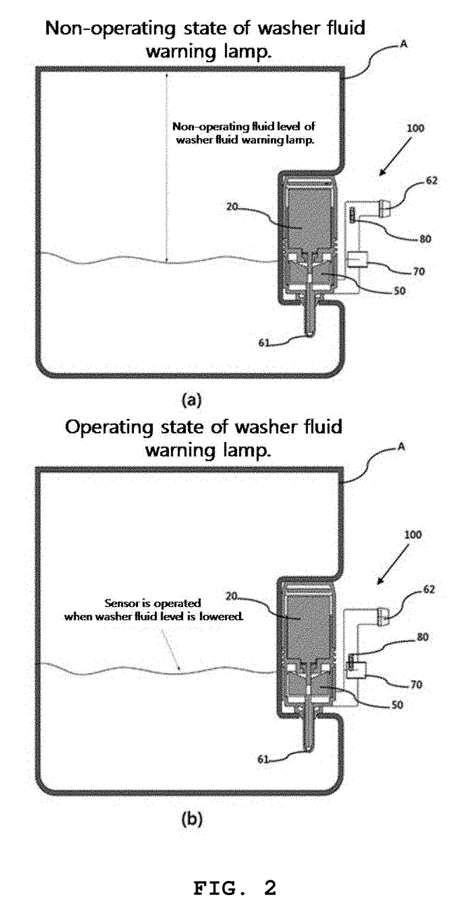

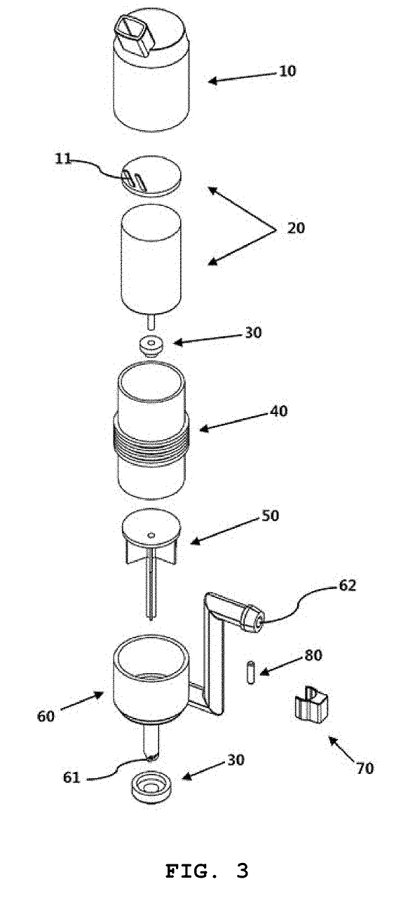

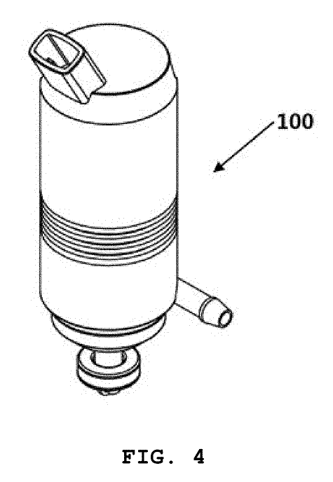

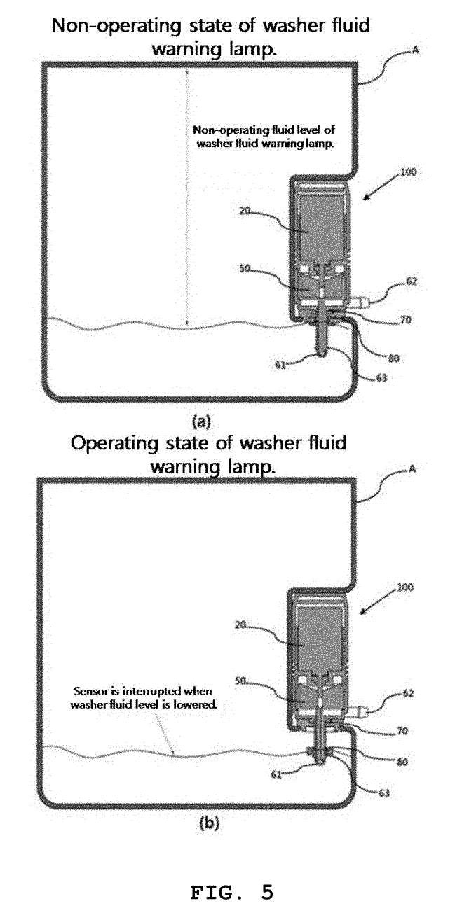

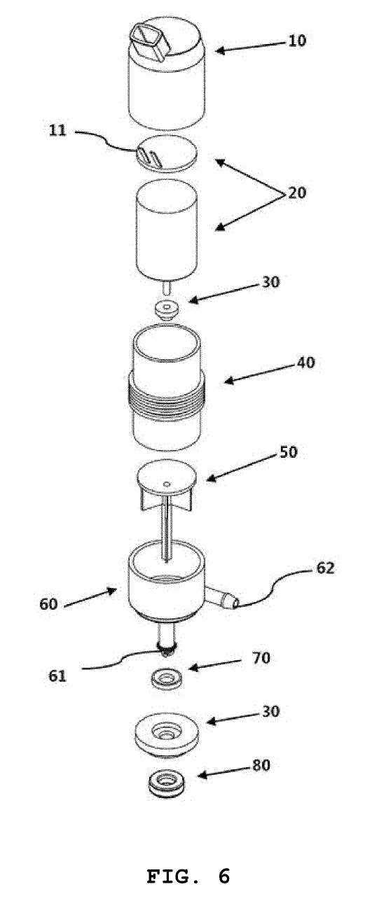

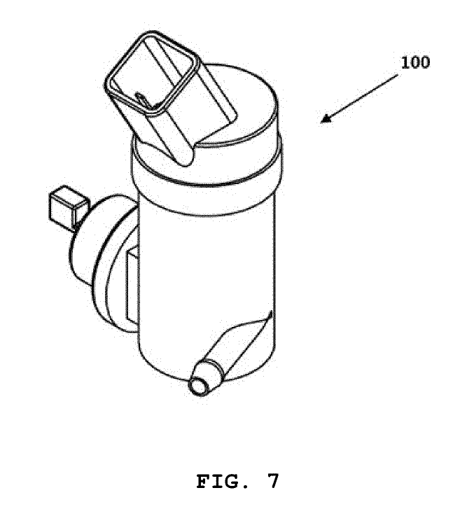

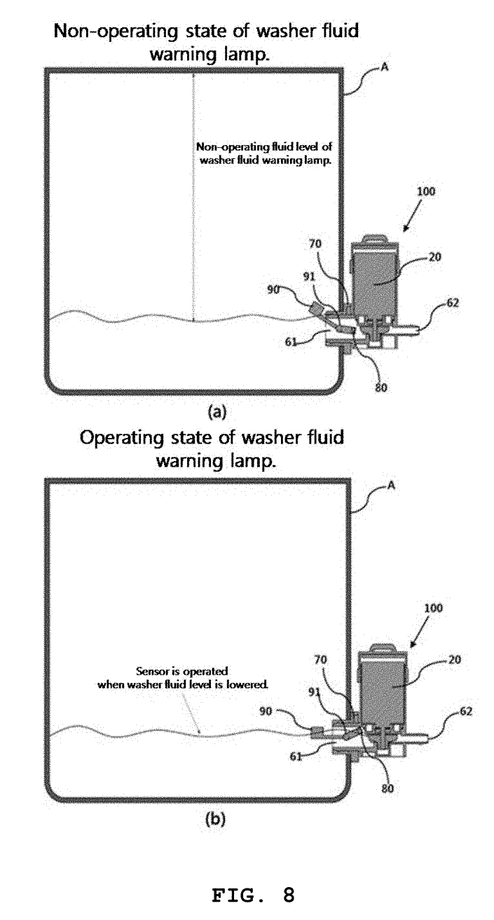

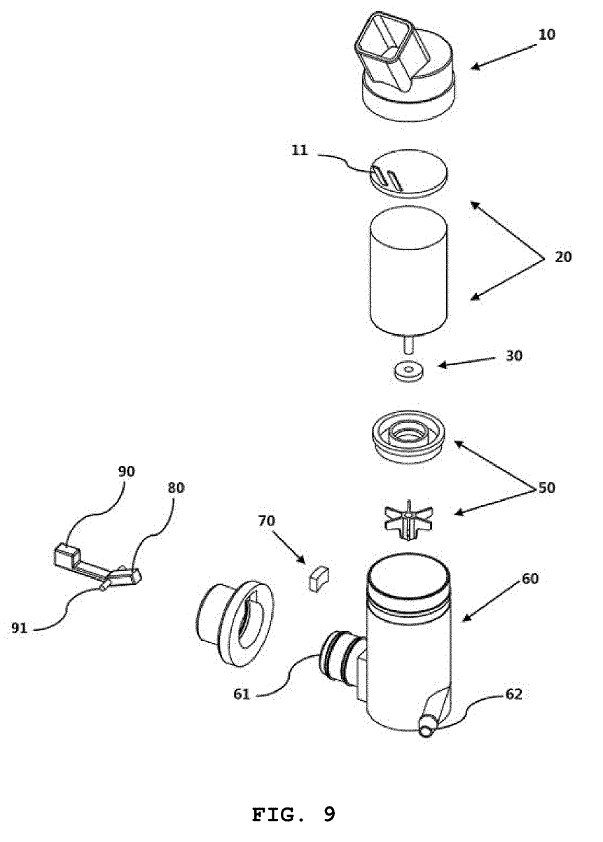

FIG. 1 is an assembled perspective view showing a fluid level sensor-attached motor pump for a washer fluid mounted to a washer fluid reservoir, in which the fluid level sensor is mounted to a tube formed at an outer circumferential side of a pumping casing according to an embodiment of the present invention, FIG. 2 shows a non-operating state (a) and an operating state (b) of a washer fluid warning lamp in a fluid level sensor-attached motor pump for a washer fluid mounted to a washer fluid reservoir, in which the fluid level sensor is mounted to a tube formed at the outer circumferential side of a pumping casing according to an embodiment of the present invention, FIG. 3 is an exploded perspective view showing a fluid level sensor-attached motor pump for a washer fluid according to an embodiment of the present invention, FIG. 4 is an assembled perspective view showing a fluid level sensor-attached motor pump for a washer fluid mounted to a washer fluid reservoir, in which the fluid level sensor is mounted to a tube formed at a lower end portion of a pumping casing according to another embodiment of the present invention, FIG. 5 shows a non-operating state (a) and an operating state (b) of a washer fluid warning lamp in a fluid level sensor-attached motor pump for a washer fluid mounted to a washer fluid reservoir, in which the fluid level sensor is mounted to a tube formed at the lower end portion of a pumping casing according to another embodiment of the present invention, FIG. 6 is an exploded perspective view showing a fluid level sensor-attached motor pump for a washer fluid according to another embodiment of the present invention, FIG. 7 is an assembled perspective view showing a fluid level sensor-attached motor pump for a washer fluid mounted to a washer fluid reservoir, in which the fluid level sensor is mounted to a branched tube of a pumping casing into which a washer fluid is sucked according to still another embodiment of the present invention, FIG. 8 shows a non-operating state (a) and an operating state (b) of a washer fluid warning lamp in a fluid level sensor-attached motor pump for a washer fluid mounted to a washer fluid reservoir, in which the fluid level sensor is mounted to the branched tube of a pumping casing into which a washer fluid is sucked according to still another embodiment of the present invention, and FIG. 9 is an exploded perspective view showing a fluid level sensor-attached motor pump for a washer fluid according to still another embodiment of the present invention.

A fluid level sensor-attached motor pump 100 for a washer fluid according to the present invention is composed of a power supply connector casing 10, a power supply connector 11, a motor assembly 20, a rubber packing 30, a motor cover 40, a fan 50, a pumping casing 60, a suction port 61, a discharge port 62, a step 63, a Hall sensor 70, a magnet 80, a buoyancy device 90, a hinge 91 and the like.

As shown in FIGS. 1 to 6, the fluid level sensor-attached motor pump 100 for a washer fluid includes: a casing (10, 40, 60) configured to protect the constituent components of the motor pump 100; a power supply connector 11 configured to supply electric power to the motor pump 100; a motor assembly configured to receive the electric power from the power supply connector 11 so as to be driven to allow a washer fluid stored in a washer fluid reservoir A to be sucked into the casing or discharged from the casing; a fan 50 rotated by the drive of the motor assembly 20; and a fluid level sensor (70, 80) inserted into a tube formed at a lower end portion of a pumping casing 60 in which the fan 50 is mounted, the tube having formed therein a suction port 61 through which the washer fluid is sucked into the casing, or a tube formed at an outer circumferential side of the pumping casing 60 and having formed therein a discharge port 62 through which the washer fluid is discharged from the casing, the fluid level sensor being configured to detect the remaining amount of the washer fluid in the washer fluid reservoir using either a combination of a magnet 80 and a Hall sensor 70 or a combination of the magnet and a reed switch 71 and output a detection signal.

The functions of respective technical means constituting the fluid level sensor-attached motor pump for a washer fluid according to the present invention will be described hereinafter.

The casing (10, 40, 60) functions to protect the constituent components of the motor pump 100. Herein, the casing includes: a power supply connector casing 10 configured to surround the power supply connector 11; a motor cover 40 coupled at an upper end portion thereof to a lower end portion of the power supply connector casing 10 and coupled at a lower end portion thereof to an upper end portion of the pumping casing 60, the motor cover 40 being configured to protect the motor assembly 20; and the pumping casing 60 configured to surround the fan 50 and formed with the suction port 61 and the discharge port 62 for the washer fluid.

The power supply connector 11 functions to supply electric power to the motor pump 100.

The motor assembly 20 functions to receive the electric power from the power supply connector 11 so as to be driven to rotate the fan 50 to allow a washer fluid stored in the washer fluid reservoir A to be sucked into the casing through the suction port 61 or to be discharged from the casing through the discharge port 62.

The fan 50 is rotated by the drive of the motor assembly 20.

The fluid level sensor (70, 80) is inserted into a tube formed at the lower end portion of the pumping casing 60 in which the fan 50 is mounted, the tube having formed therein the suction port 61 through which the washer fluid is sucked into the casing, or a tube formed at an outer circumferential side of the pumping casing 60 and having formed therein the discharge port 62 through which the washer fluid is discharged from the casing. The fluid level sensor is configured to detect the remaining amount of the washer fluid in the washer fluid reservoir using either a combination of a magnet 80 and a Hall sensor 70 or a combination of the magnet and a reed switch 71 and output a detection signal. Herein, the Hall sensor 70 is implemented as a magnetic sensor whose electrical resistance varies under a magnetic field and which uses a semiconductor Hall element of InSb, InAs or GaAs. The semiconductor Hall element can be replaced with a magneto-resistance element.

In addition, the fluid level sensor-attached motor pump 100 for a washer fluid may further include a rubber packing 30 interposed between the motor assembly 20 and the fan 50 and between the Hall sensor 70 and the magnet 80, or between the motor assembly 20 and the fan 50 and around the tube formed at the lower end portion of the pumping casing 60 so as to maintain airtightness.

As shown in FIG. 6, a step 63 is formed on the tube having formed therein the suction port 61 through which the washer fluid is sucked into the pumping casing so as to prevent escape of a lower end portion of a buoyant magnet 80 that is fit around the tube.

As shown in FIGS. 1 to 3, in the case where the fluid level sensor is mounted to a tube formed at an outer circumferential side of the pumping casing in the fluid level sensor-attached motor pump 100 for a washer fluid mounted to the washer fluid reservoir, a principle of detecting the washer fluid level of the washer fluid reservoir is as follows: In the case of a non-operating state (FIG. 2(a)) of a washer fluid warning lamp, the Hall sensor 70 and the magnet 80 are separated from each other by a buoyant force caused by the washer fluid introduced into the tube formed with the suction port 61 in the motor pump 100 connected to the washer fluid reservoir A. Then, when the operating mode of the washer fluid warning lamp is switched from the non-operating state to the operating state (FIG. 2(b)), the washer fluid level of the washer fluid reservoir A is lowered and the Hall sensor 70 is operated to cause the magnet 80 to be moved to come into close contact with the Hall sensor 70. As such, the movement position of the magnet depending on the amount of the washer fluid is detected by the Hall sensor 70 which in turn outputs a detection signal as an electrical signal so that the insufficient state of the washer fluid can be checked through the washer fluid warning lamp. In addition, the Hall sensor may be replaced with a reed switch 7 so that the insufficient state of the washer fluid can also be checked through the washer fluid warning lamp.

Further, as shown in FIGS. 4 to 6, in the case where the fluid level sensor is mounted to a tube formed at a lower end portion of the pumping casing in the fluid level sensor-attached motor pump 100 for a washer fluid mounted to the washer fluid reservoir, a principle of detecting the washer fluid level of the washer fluid reservoir is as follows: In the case of a non-operating state (FIG. 5(a)) of the washer fluid warning lamp, the Hall sensor 70 and the magnet 80 are integrally coupled to each other by the washer fluid introduced into the tube formed with the suction port 61 in the motor pump 100 connected to the washer fluid reservoir A. Then, when the operating mode of the washer fluid warning lamp is switched from the non-operating state to the operating state (FIG. 5(b)), the washer fluid level of the washer fluid reservoir A is lowered and the operation of the Hall sensor 70 is interrupted to cause the magnet 80 to be moved toward an entrance of the suction port 61 so as to be separated from the Hall sensor 70. As such, the movement position of the magnet depending on the amount of the washer fluid is detected by the Hall sensor 70 which in turn outputs a detection signal as an electrical signal so that the insufficient state of the washer fluid can be checked through the washer fluid warning lamp. In addition, the Hall sensor may be replaced with the reed switch 7 so that the insufficient state of the washer fluid can also be checked through the washer fluid warning lamp.

In addition, as shown in FIGS. 7 to 9, the fluid level sensor-attached motor pump 100 for a washer fluid according to the present invention includes: a power supply connector casing 10 coupled to an upper end portion of a pumping casing 60 and configured to surround a power supply connector 11; a power supply connector 11 configured to supply electric power to the motor pump 100; a motor assembly 20 configured to receive the electric power from the power supply connector 11 so as to be driven to allow a washer fluid stored in a washer fluid reservoir A to be sucked into the pumping casing or discharged from the pumping casing through a discharge port 62; a fan 50 rotated by the drive of the motor assembly 20; and a fluid level sensor (70, 80, 90) inserted into a tube formed at a lower outer circumferential side of the pumping casing 60 in which the motor assembly 20 and the fan 50 are mounted, the tube having formed therein a suction port 61 through which the washer fluid is sucked into the pumping casing, the fluid level sensor being configured to detect the remaining amount of the washer fluid in the washer fluid reservoir using a combination of a Hall sensor 70 and a buoyancy device 90 connected to a magnet 80 by means of a hinge 91 and output a detection signal.

The functions of respective technical means constituting the fluid level sensor-attached motor pump for a washer fluid according to the present invention will be described hereinafter.

The power supply connector casing 10 is coupled to the upper end portion of the pumping casing 60 and functions to surround the power supply connector 11.

The power supply connector 11 functions to supply electric power to the motor pump 100.

The motor assembly 20 functions to receive the electric power from the power supply connector 11 so as to be driven to rotate the fan 50 to allow the washer fluid stored in a washer fluid reservoir A to be sucked into the pumping casing through the suction port 61 or discharged from the pumping casing through the discharge port 62.

The fan 50 is rotated by the drive of the motor assembly 20.

The fluid level sensor (70, 80, 90) is inserted into a tube formed at the lower outer circumferential side of the pumping casing 60 in which the motor assembly 20 and the fan 50 are mounted, the tube having formed therein a suction port 61 through which the washer fluid is sucked into the pumping casing. The fluid level sensor is configured to detect the remaining amount of the washer fluid in the washer fluid reservoir using a combination of the Hall sensor 70 and the buoyancy device 90 connected to the magnet 80 by means of the hinge 91 and output a detection signal.

As shown in FIGS. 7 to 9, in the case where the fluid level sensor is mounted to a branched tube of the pumping casing into which a washer fluid is sucked in the fluid level sensor-attached motor pump 100 for a washer fluid mounted to the washer fluid reservoir, a principle of detecting the washer fluid level of the washer fluid reservoir is as follows: In the case of a non-operating state (FIG. 8(a)) of a washer fluid warning lamp, the buoyancy device 90 connected to the magnet 80 by means of the hinge 91 is moved upwardly to cause the magnet 80 to be separated from the Hall sensor 70 by the washer fluid introduced into the tube formed with the suction port 61 in the motor pump 100 connected to the washer fluid reservoir A. Then, when the operating mode of the washer fluid warning lamp is switched from the non-operating state to the operating state (FIG. 8(b)), the washer fluid level of the washer fluid reservoir A is lowered and the Hall sensor 70 is operated. At this time, the buoyancy device 90 is moved downwardly to cause the magnet 80 to come into close contact with the Hall sensor 70. As such, the vertical movement of the magnet depending on the amount of the washer fluid is detected by the Hall sensor 70 which in turn outputs a detection signal as an electrical signal so that the insufficient state of the washer fluid can be checked through the washer fluid warning lamp.

In the fluid level sensor-attached motor pump for a washer fluid as described above, the color of the washer fluid warning lamp varies depending on the amount of the washer fluid so that the washer fluid level of the washer fluid reservoir can be checked through a change in the color of the washer fluid warning lamp. For example, when the washer fluid reservoir is fully filled with the washer fluid, the color of the washer fluid warning lamp is changed into blue, and when the washer fluid reservoir is filled two-thirds full with the washer fluid, the color of the washer fluid warning lamp is changed into red-yellow. In addition, when the washer fluid in the washer fluid reservoir is insufficient, the color of the washer fluid warning lamp is changed into red.

While the present invention has been described in connection with the preferred embodiments illustrated in the drawings and the specification, they are merely illustrative and the invention is not limited to these embodiments. The terms used herein are used for the purpose of describing the present invention, but is not intended to limit the meaning of the terms or the scope of the present invention set forth in the claims. It will be appreciated by a person having an ordinary skill in the art that various equivalent modifications and variations of the embodiments can be made without departing from the spirit and scope of the present invention. Therefore, the true technical scope of the present invention should be defined by the technical sprit of the appended claims.

### INDUSTRIAL APPLICABILITY

The fluid level sensor-attached motor pump for a washer fluid according to an embodiment of the present invention as described above can be applied to various kinds of vehicles and aircrafts, and thus the use and coverage thereof is broadened.

1. A fluid level sensor-attached motor pump for a washer fluid, comprising:
a casing configured to protect the constituent components of the motor pump;
a power supply connector configured to supply electric power to the motor pump;
a motor assembly configured to receive the electric power from the power supply connector so as to be driven to allow a washer fluid stored in a washer fluid reservoir to be sucked into the casing or discharged from the casing;
a fan rotated by the drive of the motor assembly; and
a fluid level sensor inserted into a tube formed at a lower end portion of a pumping casing in which the fan is mounted, the tube having formed therein a suction port through which the washer fluid is sucked into the casing, or a tube formed at an outer circumferential side of the pumping casing and having formed therein a discharge port through which the washer fluid is discharged from the casing, the fluid level sensor being configured to detect the remaining amount of the washer fluid in the washer fluid reservoir using either a combination of a magnet and a Hall sensor or a combination of the magnet and a reed switch and output a detection signal.

2. The fluid level sensor-attached motor pump for a washer fluid according to claim 1, wherein the casing comprises: a power supply connector casing configured to surround the power supply connector; a motor cover coupled at an upper end portion thereof to a lower end portion of the power supply connector casing and coupled at a lower end portion thereof to an upper end portion of the pumping casing, the motor cover being configured to protect the motor assembly; and the pumping casing configured to surround the fan and formed with the suction port and the discharge port for the washer fluid.

3. The fluid level sensor-attached motor pump for a washer fluid according to claim 1, further comprising a rubber packing interposed between the motor assembly and the fan and between the Hall sensor and the magnet, or between the motor assembly and the fan and around the tube formed at the lower end portion of the pumping casing so as to maintain airtightness.

4. The fluid level sensor-attached motor pump for a washer fluid according to claim 1, wherein a step is formed on the tube having formed therein the suction port through which the washer fluid is sucked into the pumping casing so as to prevent escape of a lower end portion of a buoyant magnet that is fit around the tube.

5. A fluid level sensor-attached motor pump for a washer fluid, comprising:
a power supply connector casing coupled to an upper end portion of a pumping casing and configured to surround a power supply connector;
a power supply connector configured to supply electric power to the motor pump;
a motor assembly configured to receive the electric power from the power supply connector so as to be driven to allow a washer fluid stored in a washer fluid reservoir A to be sucked into the pumping casing or discharged from the pumping casing through a discharge port;
a fan rotated by the drive of the motor assembly; and
a fluid level sensor inserted into a tube formed at a lower outer circumferential side of the pumping casing in which the motor assembly and the fan are mounted, the tube having formed therein a suction port through which the washer fluid is sucked into the pumping casing, the fluid level sensor being configured to detect the remaining amount of the washer fluid in the washer fluid reservoir using a combination of a Hall sensor and a buoyancy device connected to a magnet by means of a hinge and output a detection signal.

6. The fluid level sensor-attached motor pump for a washer fluid according to claim 1, wherein the Hall sensor is implemented as a magnetic sensor whose electrical resistance varies under a magnetic field and which uses a semiconductor Hall element of InSb, InAs or GaAs.

7. The fluid level sensor-attached motor pump for a washer fluid according to claim 5, wherein the Hall sensor is implemented as a magnetic sensor whose electrical resistance varies under a magnetic field and which uses a semiconductor Hall element of InSb, InAs or GaAs.
